(19) United States
(12) Patent Application Publication
(10) Pub. No.: US 2025/0094836 A1
(43) Pub. Date: Mar. 20, 2025

(54) DECISION INTELLIGENCE PLATFORM AND METHOD FOR DECISION INTELLIGENCE PLATFORM

(71) Applicant: ATOS FRANCE, Bezons (FR)

(72) Inventor: Yannick LECROART, La Grand Motte (FR)

(73) Assignee: ATOS FRANCE, Bezons (FR)

(21) Appl. No.: 18/887,586

(22) Filed: Sep. 17, 2024

(30) Foreign Application Priority Data
Sep. 18, 2023 (EP) 23306535.8

(51) Int. Cl. G06N 5/022

(52) U.S. Cl. CPC G06N 5/022

(57) ABSTRACT

A decision intelligence platform comprising a decision data warehouse and an execution agent to perform one processing chain in order to ingest source data and feed the decision data warehouse. The platform accesses a governance document describing the processes in the processing chain and, for one or several processes in the processing chain, one or several governance rules and checks relating to the governance rules. And, when a process in the processing chain is executed, the checks described in the governance document are carried out and an alert is raised when a check fails.

This application claims priority to European Patent Application Number 23306535.8, filed 18 Sep. 2023, the specification of which is hereby incorporated herein by reference.

### BACKGROUND OF THE INVENTION

### Field of the Invention

The various example embodiments described herein relate to a decision intelligence platform and a method to be executed by a decision intelligence platform to perform a processing chain in order to ingest source data and feed a decision data warehouse of the decision intelligence platform.

### Description of the Related Art

A decision intelligence platform comprises a decision data warehouse and an execution agent to perform at least one processing chain in order to ingest source data and feed the decision data warehouse. The data warehouse may, for example, be queried by a user via a portal to obtain decision intelligence reports.

The source data to be ingested by the decision intelligence platform comes from a variety of sources and is by its very nature evolving.

For example, following an update to a decision intelligence platform user's catalog or organization, parameters can be added, deleted or modified. The various contributors supplying source files may also make modifications to these files, for example columns can be added, deleted, moved or renamed in the source files. In cases where data is collected from Internet of Things (IoT) sensors, changes can also be made to the network frames used to feed data back to the decision intelligence platform. For example, software updates to connected objects can lead to modifications.

Any change relating to the source data can lead to a rupture in the processing chain executed by the decision intelligence platform.

In the event of a rupture in the processing chain, a decision intelligence platform application update is required, which introduces a more or less long delay depending on the availability of the application maintenance teams of the platform and the scale and volume of the changes to be managed.

### BRIEF SUMMARY OF THE INVENTION

According to at least one embodiment, a decision intelligence platform is proposed, which comprises a decision data warehouse and an execution agent for performing at least one processing chain in order to ingest source data and feed the decision data warehouse, characterized in that the execution agent is configured to:
read a governance document describing the processes in the processing chain and, for one or more processes in the processing chain, one or more governance rules and checks relating to the governance rules,
perform the checks described in the governance document when a process in the processing chain is executed,
raise an alert when a check fails.

In at least one embodiment, the decision intelligence platform comprises an integration agent triggered when a modification is made to the governance document, the integration agent being configured to read the modified governance document, perform one or more processes described in the modified governance document, perform the checks described in the modified governance document for the processes performed, and raise an alert when a check fails.

According to one or more embodiments, a method is proposed which is intended to be executed by a decision intelligence platform to perform at least one processing chain in order to ingest source data and feed a decision data warehouse of the decision intelligence platform. The proposed method comprises:
reading a governance document describing the processes in the processing chain and, for one or more processes in the processing chain, one or more governance rules and checks relating to the governance rules,
when a process in the processing chain is executed, performing the checks described in the governance document, for the process performed,
raising an alert when a check fails.

In at least one embodiment, the proposed method comprises detecting a modification to the governance document, and following said detection, reading the modified governance document, performing one or more of the processes described in the modified governance document, performing the checks described in the modified governance document for the processes performed, and raising an alert when a check fails.

In at least one embodiment, the governance document describes an access path to the source data and a check of the correct operation of the access path to be performed when executing the process(es) in order to ingest the source data.

In at least one embodiment, the governance document describes a format of the source data and a conformity check of the source data with said format, to be performed when executing the process(es) to ingest the source data.

In at least one embodiment, the decision intelligence platform comprises an operational data store into which the data ingested by the decision intelligence platform is loaded, and the governance document describes a data transcoding rule to be applied to the source data so that the ingested data loaded into the operational data store belongs to a data reference model known from the operational data store.

In at least one embodiment, the decision intelligence platform comprises an operational data store comprising intermediate tables, the governance document describes a structure of the operational data store and a conformity check with the structure of the operational data store, to be performed when executing a process in the processing chain that impacts one or more intermediate tables.

In at least one embodiment, the governance document describes a decision data warehouse structure and a conformity check with the decision data warehouse structure, to be performed when executing the process(es) in order to feed the decision data warehouse.

According to one or more embodiments, a computer program and a computer program product are provided, the computer program comprising instructions which, when executed by a processor, implement the method in any one or more of the one or more embodiments taken in combination. In at least one embodiment, the computer program product is in the form of a computer-readable medium or directly loadable into a computer.

The execution and integration agents may consist of software means, that is, instructions intended to be executed by a set of circuits in order to perform one or several or all of the operations or steps to be carried out by the decision intelligence platform in application of the methods described in one or more embodiments. The set of circuits may be made up of dedicated circuitry, in at least one embodiment. It may also be made up of one or several processors and one or several memories comprising one or more computer program codes, said processors, memories and computer codes being configured to cause the decision intelligence platform to perform one or several or all of the steps of the methods described herein, by way of one or more embodiments of the invention.

### BRIEF DESCRIPTION OF THE DRAWINGS

The one or more embodiments will be better understood in light of the following detailed description and accompanying drawings, which are given by way of illustration only and therefore do not limit the present disclosure.

FIG. 1A is a diagram giving a functional description of an example of a decision intelligence platform according to the state of the art.

FIG. 1B. is a diagram giving a functional description of an example of a decision intelligence platform according to one or more embodiments of the invention.

FIG. 2 is a diagram describing an example of the execution of a source data extraction process (commonly referred to as ETL) according to one or more embodiments of the invention.

FIG. 3 is a diagram describing an example of the execution of source data transcoding processing according to one or more embodiments of the invention.

FIG. 4 is a diagram describing an example of the execution of processing at the data store level according to one or more embodiments of the invention.

FIG. 5 is a diagram describing an example of the execution of a process for feeding a decision data table from the decision data warehouse with the transformed data produced by the operational data store, according to one or more embodiments of the invention.

FIG. 6 is a diagram describing the steps implemented by an example integration agent according to one or more embodiments of the invention.

FIG. 7 is a block diagram of a device hosting a platform according to one or more embodiments of the invention.

### DETAILED DESCRIPTION OF THE INVENTION

Various embodiments will now be described in more detail, by way of non-limiting examples, with reference to the drawings accompanying the one or more embodiments of the invention and illustrating certain example embodiments.

The specific structural and functional details described herein are non-limiting examples according to one or more embodiments of the invention. The one or more embodiments described herein are subject to various modifications and alternative forms. The subject matter of the disclosure may be embodied in many different forms and shall not be construed as being limited to the only embodiments presented herein as illustrative examples. It should be understood that there is no intention to limit the one or more embodiments to the particular forms described in the remainder of this document.

A decision intelligence platform typically comprises a decision data warehouse and an execution agent for executing one or more processing chains designed to ingest source data and feed the decision data warehouse.

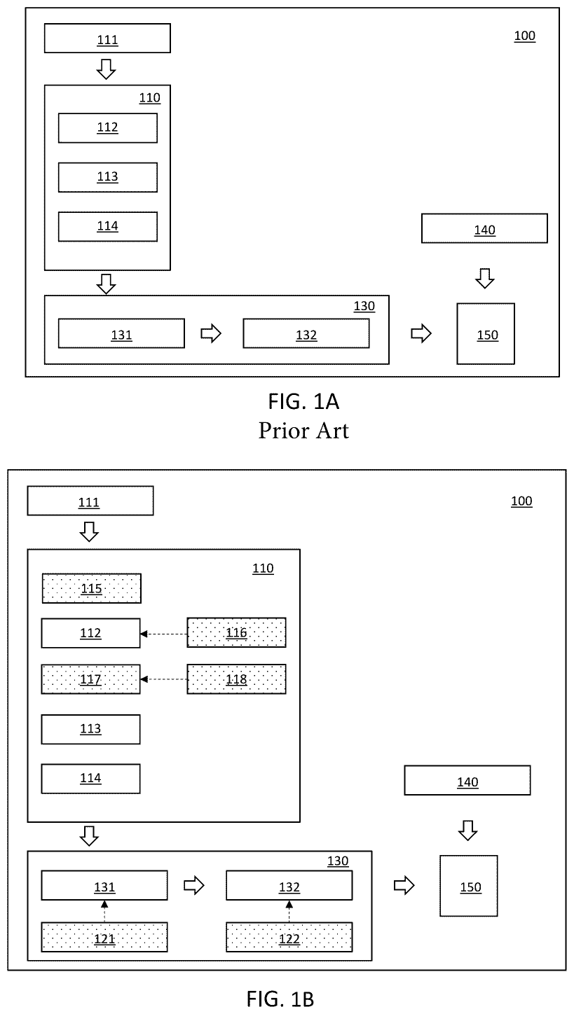

FIG. 1A is a diagram giving a functional description of an example of a decision intelligence platform according to the state of the art. This platform 100 comprises an ETL (Extract-Transform-Load) module referenced 110 and a backend module referenced 130. The ETL module 110 accesses source data contained in one or several source files 111 from one or several sources. It executes an extraction process 112, optionally (depending on the use case) one or several transformation processes 113, and a loading process 114 to load data into the backend module 130. The backend module 130 typically comprises an operational data store 131 and a data warehouse 132. The operational data store 131 centralizes data from different sources, known as ingested data, stores it temporarily and carries out processing in order to produce data compatible with the decision data warehouse 132. The data loaded by the ETL module into the operational data store 131, or produced by the operational data store 131, is stored in tables in the operational data store, known as intermediate tables. The decision data warehouse 132 is optimized for data analysis. It is fed by data produced by the operational data store 131. It may be queried by a user or an analyst 140, for example via a data analysis and visualization tool 150.

For example, processing 113 carried out by the ETL module 110 may include cleaning source data to eliminate errors, inconsistencies or duplicates, and transcoding data to make it compatible with a data reference model known from the decision intelligence platform.

The processing carried out by the operational data store 131 may include transformations on the data, for example a modification of the format, structure, type or content of the data in order to make the data compatible with the structure of the decision data warehouse 132. These transformations may for example involve conversion, aggregation, normalization, denormalization, calculation or the creation of new variables.

According to the state of the art, all of this processing is hard-coded.

In one application example, the decision intelligence platform is used by a company to manage a fleet of cell phones for its employees, the cell phones being operated by a telecoms service provider. For example, the source data contains data from the operator (for example, usage and billing data), HR data from the company (for example, data relating to the organizational structure of the company and the employees thereof), purchasing data also from the company (for example, a catalog of cell phones used in the company). A decision analyst can query the decision intelligence platform in order to obtain reports used to manage the cell phone fleet. The decision intelligence platform may be owned by the company and hosted on site or be hosted in a public cloud infrastructure. The telecoms service provider has no access to the decision intelligence platform and has no knowledge of the behavior thereof.

According to at least one embodiment of the invention, a governance document is provided that describes the processes in the processing chain to be executed by the decision intelligence platform in order to ingest source data and feed the decision data warehouse and, for one, several or all of the processes in this processing chain, one or several governance rules and checks relating to the governance rules that must be performed by the execution agent when executing the processes in the processing chain. This governance document, in at least one embodiment, is stored for example in a memory of the decision intelligence platform, or in any other space accessible by the platform.

In at least one embodiment, the decision intelligence platform comprises an integration agent that is triggered when a modification is made to the governance document. This integration agent, in one or more embodiments, is configured to read the modified governance document and perform the checks described in the modified governance document when executing processes in the processing chain described in the modified governance document.

These checks, in at least one embodiment, are used to confirm that processes are running correctly and that there are no ruptures in the processing chain. If a check fails, in one or more embodiments, the execution agent or integration agent raises an alert.

The processing chain may be ruptured by a modification relating to the source data, by way of at least one embodiment. In this case, in one or more embodiments, the rupture is identified in production by the execution agent when the processes in the processing chain are executed thanks to the checks performed. An alert is then raised allowing human intervention to correct the problem, according to one or more embodiments of the invention.

Ruptures may also occur as a result of a modification made to the content of the governance document by the platform user. In at least one embodiment, the platform detects the modification and triggers the integration agent which executes, in an environment distinct from the production environment (for example a test, development and/or integration environment), one or several processes in the processing chain, and performs the checks associated with the processes performed in the modified governance document. In one or more embodiments, the rupture is identified by the integration agent. An alert is raised allowing human intervention to correct the problem, according to one or more embodiments of the invention.

In at least one embodiment, the integration agent is triggered only after an analysis of the modification made to the governance document and confirmation by a human contributor that the modification is justified and should be integrated.

In at least one embodiment, a dynamic mapping table is also provided to define data transcoding rules between a source data reference model and a data reference model known from the operational data store 131. The source data reference model can thus be modified by the platform user, by adding, deleting or changing names. The platform user must then update the transcoding rules in the mapping table to ensure that any source data has a match in the data reference model known from the operational data store 131. The access path to the dynamic mapping table is, for example, included in the governance document. Transcoding is carried out before the data is loaded into the operational data store 131, by way of at least one embodiment. The at least one embodiment allows the company using the platform to upgrade its source data reference model without impacting the processing chain or requiring the platform application maintenance team to perform updates on the processing source code.

FIG. 1B is a diagram giving a functional description of an example decision intelligence platform according to one or more embodiments of the invention, which uses a governance document as described above.

As shown in FIG. 1B, by way of at least one embodiment, upstream of extraction processing 112, the ETL module 110 reads 115 the governance document. It then performs the checks 116, described in the governance document in connection with the extraction process 112.

For example, in at least one embodiment, the governance document describes an access path to the source data, at least one expected format for the source data, a check of the correct operation of the access path in order to validate that the source data can indeed be accessed from the access path indicated in the governance document, and a check of the format of the source data to confirm that it corresponds to the expected format.

Following these checks 116, in one or more embodiments, the ETL module 110 reads 117 the dynamic mapping table, checks the naming of the data to be ingested against the data reference model known from the operational data store 131, and if necessary, transcodes the source data by applying the transcoding rule described in the dynamic mapping table. This check and transcoding 118 ensures that all the data to be ingested into the operational data store 131 belongs to the data reference model known from the operational data store 131, according to one or more embodiments of the invention.

The ETL module 110 then performs the next processing steps in the processing chain, that is, the transformation processes 113 and then the processes 114 for loading the data into the operational data store 131.

In at least one embodiment, the governance document describes a structure of the operational data store 131, that is, the various constituent intermediate tables. It also describes checks to be carried out when data is loaded into an intermediate table, to ensure that the loaded data conforms to the structure of the operational data store. These checks may concern the format of the data loaded and the size thereof, in at least one embodiment.

When data is loaded into an intermediate table in the operational data store 131, a check 121 is thus performed to validate that the data has been loaded in accordance with the structure of the operational data store 131 as described in the governance document, according to one or more embodiments of the invention.

In at least one embodiment, the governance document describes a decision data warehouse structure and checks to be performed when executing the process(es) to feed the decision data warehouse 132 from the operational data store 131 in order to ensure that the data loaded conforms to the structure of the decision data warehouse 132.

When data is loaded into a table in the decision data warehouse 132 in at least one embodiment, a check 122 is thus performed to confirm that the data has been loaded in accordance with the structure of the decision data warehouse 132 as described in the governance document.

The governance document may be composed of one or several files, for example of CSV, YAML, XML or other types. The governance document is declarative, in at least one embodiment. It can be read and understood by a human user.

For example, in one or more embodiments, it is possible to structure the governance document into a plurality of governance plans, with each governance plan being stored in a specific file.

An example of the structure of a governance document in several governance plans will now be given for illustrative purposes. In this example, by way of one or more embodiments, the governance document comprises a main plan, a general governance plan, a governance plan associated with the ETL module 110, a governance plan associated with the operational data store 131 and a governance plan associated with the decision data warehouse 132. This embodiment is not limiting. The governance document can be organized in many other ways, according to one or more embodiments of the invention.

The master plan, stored in a master file, defines the location of the files associated with each of the governance plans that make up the governance document, according to one or more embodiments of the invention.

The general governance plan describes the infrastructure and services to be used by the execution agent or by the integration agent, as well as the name of at least one computer process to be executed within these environments in connection with at least one processing chain, in one or more embodiments. For example, the general governance plan may indicate that a process called “mobile fleet” is to be run, and specify an orchestration tool to be used to run this process (for example Microsoft Azure).

The ETL module governance plan describes the various processes to be carried out by the ETL module as part of the general process associated with the processing chain (for example “mobile fleet”) and, for each process, indicates the processing to be carried out, the applicable rules and the checks to be performed, according to one or more embodiments of the invention. For example, the “mobile fleet” process mentioned in the general governance plan may use a process for extracting data from the telecoms operator and, for this process, the ETL module governance plan may indicate:
a data extraction process 112 to be carried out,
a path to a source data file to follow in order to obtain the source data,
a check that the access path is working properly,
columns expected in the source data file (for example a “Period” column, a “Company name” column, a “Company code” column, a “Customer account” column, a “Subscriber number” column, etc.),
a check of the presence of said columns.

The “mobile fleet” process may also use a process for extracting data from a company HR database and a process for extracting data from a company purchasing database, the governance plan for these two other processes being similar to that just described for extracting data from the telecoms operator.

In at least one embodiment, the governance plan of the ETL module comprises an access path to the dynamic mapping table described above, allowing a source data naming check to be performed and, if necessary, transcoding of this data.

The governance plan of the operational data store 131, in at least one embodiment, describes the structure of the operational data store 131, that is, the set-up of the intermediate tables that make up the operational data store 131. For each intermediate table, in one or more embodiments, the governance plan of the operational data store 131 describes the expected columns, the type of data for each column, the checks to be performed on the data when loading data into the intermediate table, for example a check of the data type (for example a character string having less than a maximum permitted length), and a check of the number of rows loaded into the table (for example a minimum number of rows may be required to ensure that the table is not empty).

The governance plan of the decision data warehouse 132, in at least one embodiment, describes the structure of the decision data warehouse 132, that is, the set-up of the decision data tables that make up the decision data warehouse 132. For each decision data table, in one or more embodiments, the governance plan of the decision data warehouse 132 describes the expected columns, the type of data for each column, and the checks to be performed on the data when loading the data into the decision data table.

The purpose of these data type and size checks is to confirm that the data loaded into data store tables corresponds to what is expected. In other words, in at least one embodiment, they confirm that the processing chain is not impacted or broken by modifications impacting the source data. Checks carried out on the production environment allow continuous validation of the data, according to one or more embodiments of the invention.

Checks may also be carried out in a test/development/integration environment, for example when a modification of the governance document is detected. They are then used to confirm that the processing chain is not impacted or broken by modifications made to the governance document.

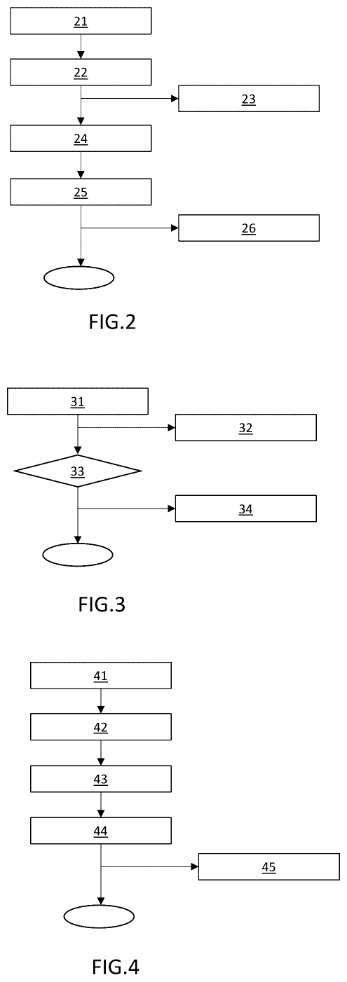

FIG. 2 is a diagram describing an execution example of source data extraction processing, according to one or more embodiments of the invention.

The first step 21 is to read the governance plan associated with the ETL module. In step 22, in accordance with the content of this governance plan, the accessibility of the source file is verified. If the file is not accessible, an alert is sent in step 23, for example by e-mail, to the team responsible for application maintenance on the platform. If the file is accessible, processing continues in step 24 by reading the source file. In step 25, the other checks stipulated in the governance plan are carried out, for example the format checks. If the check fails, that is, if the format of the source data does not comply with the rules described in the governance document, an alert is sent in step 26 to the team responsible for application maintenance on the platform. If the check is successful, execution of the processing chain continues.

FIG. 3 is a diagram describing an execution example of a source data transcoding process, according to one or more embodiments of the invention. For example, this transcoding process can be carried out following the extraction process described with reference to FIG. 2, according to one or more embodiments of the invention.

In step 31, for each data item to be ingested, the dynamic mapping table is read in order to check the data naming and, if necessary, to perform transcoding. If transcoding fails, in step 32, the data is added to an error list. In step 33, the error list is checked. If it is empty, execution of the processing chain continues. If it contains data for which transcoding has failed, an alert is sent to the team responsible for application maintenance on the platform in step 34.

FIG. 4 is a diagram describing an example execution of processing carried out at the level of the operational data store 131, according to one or more embodiments of the invention.

The first step 41 is to read the governance plan associated with the operational data store 131. In step 42, the processing described in the governance plan is executed. Once this processing has been executed, the data in the intermediate tables is extracted in step 43. And in step 44, the extracted data is checked to ensure that the structure thereof conforms to the rules described in the governance plan. If the check fails, in step 45, an alert is sent to the team responsible for application maintenance on the platform. If the check is successful, execution of the processing chain continues.

FIG. 5 is a diagram describing an example execution of a process for feeding a decision data table from the decision data warehouse 132 with the transformed data produced by the operational data store 131, according to one or more embodiments of the invention.

In step 51, data from the operational data store 131 is loaded into the decision data tables of the decision data warehouse 132. In step 52, the governance plan associated with the decision data warehouse 132 is read to obtain the structure of the decision data warehouse 132. In step 53, data is extracted from the decision data tables that make up the decision data warehouse 132. And in step 53, the extracted data is checked to ensure that the structure thereof conforms to the rules described in the governance plan. If the check fails, in step 54, an alert is sent to the team responsible for application maintenance on the platform. If the check is successful, execution of the processing chain continues.

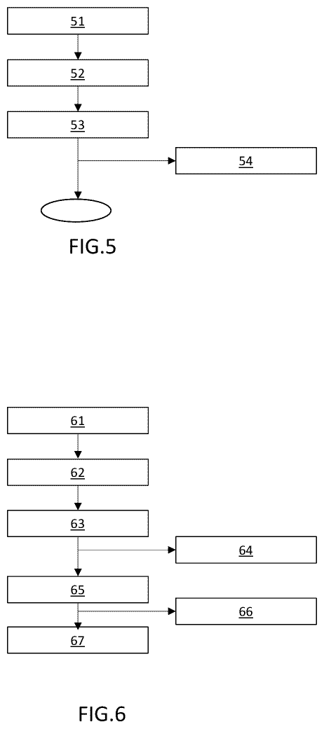

In at least one embodiment, the processing described with reference to FIG. 4 and FIG. 5 is carried out table by table, with the processing relating to the different tables running in parallel. FIG. 6 is a diagram describing the steps implemented by an example integration agent when one or several modifications need to be made to the operation of the platform after the governance document has been modified, according to one or more embodiments of the invention.

In step 61, the integration agent extracts from the governance document the information relating to the processing chain to be performed and to the methods for carrying it out. In step 62, the modification(s) is (are) deployed. In step 63, the processing chain is executed. When a process in the processing chain is executed, the checks specified in the governance document are carried out to ensure that the modifications made do not cause a rupture in the processing chain. When a check fails, an alert is sent to the team responsible for application maintenance on the platform in step 64. In step 65, the deployed code is checked for consistency. When a consistency check fails, an alert is sent in step 66. If all consistency checks pass, in step 67, the modification(s) is (are) deployed in production.

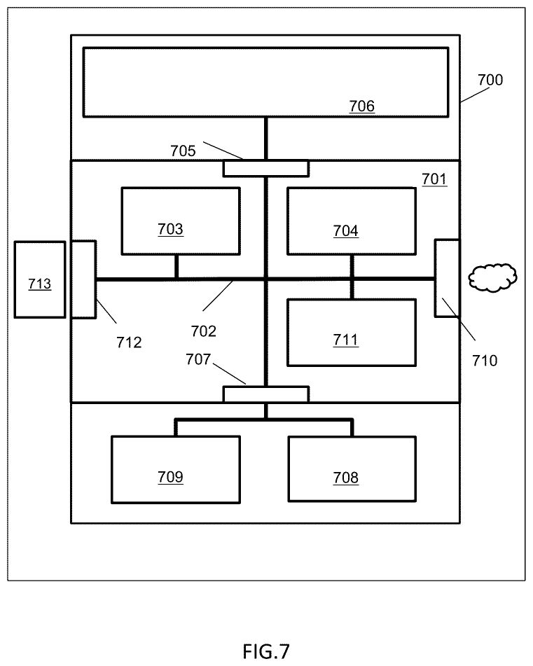

FIG. 7 represents, by way of at least one embodiment, a high-level block diagram of a device 700 for implementing a platform as described in one or more embodiments of the invention. Although shown as a single block, in one or more embodiments the platform may also be implemented using parallel and distributed architectures. And the steps mentioned in the methods described above with reference to FIGS. 2 to 6 can be performed sequentially, in parallel, or in a different order depending on particular implementations, according to one or more embodiments of the invention.

According to at least one embodiment, given as an example, shown in FIG. 7, the device 700 comprises a printed circuit board 701 on which a communication bus 702 connects a processor 703 (for example, a central processing unit “CPU”), a random access memory 704, a storage medium 711, optionally an interface 705 for connecting a screen 706, a series of connectors 707 for connecting user interface devices or modules such as a mouse or trackpad 708 and a keyboard 709, a wireless network interface 710 and/or a wired network interface 712. Depending on the functionality required, the device may implement only part of the above. Some of the modules shown in FIG. 7 may be internal or externally connected, by way of at least one embodiment, in which case they are not necessarily an integral part of the device itself. For example, the screen 706 may be a screen that is only connected to the device 700 in specific circumstances, or the device 700 may be controlled by another device equipped with a screen, in which case the device 700 has no specific screen 706 or interface 705.

The memory 711 contains one or more software codes which, when executed by the processor 703, allow the device 700 to execute the methods described herein, in particular to implement an execution agent and an integration agent. In at least one embodiment given by way of example, a removable storage medium 713, such as a USB key, may also be connected. For example, the detachable storage medium 713 may contain software codes to be downloaded into the memory 711.

The processor 703 may be any type of processor such as a central processing unit (“CPU”) or a dedicated microprocessor such as an integrated microcontroller or digital signal processor (“DSP”).

The device 700 may also comprise other components typically found in computer systems, such as an operating system, queue managers, device drivers or one or several network protocols that are stored in the memory 711 and executed by the processor 703.

Those skilled in the art will understand that all the block diagrams presented herein show conceptual views, given by way of example, of circuits incorporating the principles of the one or more embodiments of the disclosure.

Each function, block, step described may be implemented in hardware, software, firmware, middleware, microcode or any suitable combination thereof, according to one or more embodiments of the invention. If they are implemented in software, the functions or blocks of the block diagrams and flowcharts can be implemented by computer program instructions/software codes, which can be stored or transmitted on a computer-readable medium, or loaded onto a general-purpose computer, special-purpose computer or other programmable processing device and/or system, so that the computer program instructions or software codes running on the computer or other programmable processing device create the means to implement the functions described, according to one or more embodiments of the invention.

Although aspects of the invention have been described with reference to one or more embodiments, it should be understood that these embodiments merely illustrate the principles and applications of the present disclosure. It is therefore understood that numerous modifications may be made to the illustrative one or more embodiments and that other arrangements may be devised without departing from the spirit and scope of the disclosure as determined on the basis of the claims and their equivalents.

Advantages and solutions to problems have been described above with regard to specific one or more embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

1. A decision intelligence platform comprising:
a decision data warehouse and an execution agent to perform at least one processing chain in order to ingest source data and feed the decision data warehouse,
wherein the execution agent is configured to
read a governance document describing
one or more processes in the at least one processing chain, and,
for said one or more processes in the at least one processing chain, one or more governance rules and checks relating to the one or more governance rules,
perform the checks described in the governance document when a process of said one or more processes in the at least one processing chain is executed,
raise an alert when a check of said checks fails.

2. The decision intelligence platform according to claim 1, further comprising an integration agent triggered when a modification is made to the governance document, the integration agent being configured to
read the governance document that is modified,
carry out one or several of the one or more processes described in the governance document that is modified,
perform the checks described in the governance document that is modified for the one or the several of the one or more processes performed, and
raise an alert when a check, of said checks described in the governance document that is modified, fails.

3. A method intended to be executed by a decision intelligence platform to execute at least one processing chain in order to ingest source data and feed a decision data warehouse of the decision intelligence platform, the method comprising:
reading a governance document describing
one or more processes in the at least one processing chain, and,
for said one or more processes in the at least one processing chain, one or more governance rules and checks relating to the one or more governance rules,
when a process of said one or more processes in the at least one processing chain is executed, performing the checks described in the governance document, for the process that is executed,
raising an alert when a check of said checks fails.

4. The method according to claim 3, further comprising
detecting a modification to the governance document, and following said detecting
reading the governance document that is modified,
performing one or several of the one or more processes described in the governance document that is modified,
performing the checks described in the governance document that is modified for the one or the several of the one or more processes that is performed, and
raising an alert when a check, of the checks of the governance document that is modified, fails.

5. The decision intelligence platform according to claim 1, wherein the governance document further describes an access path to the source data and a check of a correct operation of the access path to be carried out when executing the one or more processes in order to ingest the source data.

6. The decision intelligence platform according to ene of claim 1, wherein the governance document further describes at least one format of the source data and a conformity check of the source data with said at least one format to be performed when executing the one or more processes to ingest the source data.

7. The decision intelligence platform according to claim 1, wherein the decision intelligence platform further comprises an operational data store into which the source data ingested by the decision intelligence platform is loaded, and the governance document further describes a data transcoding rule to be applied to the source data so that the source data that is ingested loaded into the operational data store belongs to a data reference model known from the operational data store.

8. The decision intelligence platform according to claim 1, wherein the decision intelligence platform further comprises an operational data store comprising intermediate tables, the governance document further describes a structure of the operational data store and a conformity check with the structure of the operational data store, to be performed when executing a process of the one or more processes in the at least one processing chain that impacts one or more intermediate tables of the intermediate tables.

9. The decision intelligence platform according to claim 1, wherein the governance document further describes a structure of the decision data warehouse and a conformity check with the structure of the decision data warehouse, to be performed when executing the one or more processes to feed the decision data warehouse.

10. A computer program comprising instructions which, when they are executed by a computer, implement a method intended to be executed by a decision intelligence platform to execute at least one processing chain in order to ingest source data and feed a decision data warehouse of the decision intelligence platform, the method comprising:
reading a governance document describing
one or more processes in the at least one processing chain, and,
for said one or more processes in the at least one processing chain, one or more governance rules and checks relating to the one or more governance rules,
when a process of said one or more processes in the at least one processing chain is executed, performing the checks described in the governance document, for the process that is executed,
raising an alert when a check of said checks fails.

11. The method according to claim 3, wherein the governance document further describes an access path to the source data and a check of a correct operation of the access path to be carried out when executing the one or more processes in order to ingest the source data.

12. The method according to claim 3, wherein the governance document further describes at least one format of the source data and a conformity check of the source data with said at least one format to be performed when executing the one or more processes to ingest the source data.

13. The method according to claim 3, wherein the decision intelligence platform further comprises an operational data store into which the source data ingested by the decision intelligence platform is loaded, and the governance document further describes a data transcoding rule to be applied to the source data so that the source data that is ingested loaded into the operational data store belongs to a data reference model known from the operational data store.

14. The method according to claim 3, wherein the decision intelligence platform further comprises an operational data store comprising intermediate tables, the governance document further describes a structure of the operational data store and a conformity check with the structure of the operational data store, to be performed when executing a process of the one or more processes in the at least one processing chain that impacts one or more intermediate tables of the intermediate tables.

15. The method according to claim 3, wherein the governance document further describes a structure of the decision data warehouse and a conformity check with the structure of the decision data warehouse, to be performed when executing the one or more processes to feed the decision data warehouse.
